(19) United States
(12) Patent Application Publication
(10) Pub. No.: US 2008/0080371 A1
(43) Pub. Date: Apr. 3, 2008

(54) Macro-spatial network multiplexing

(76) Inventors: Chunmei Liu, Portland, OR (US); Shailender Timiri, Hillsboro, OR (US); Muthaiah Venkatachalam, Beaverton, OR (US)

Correspondence Address: LEE & HAYES, PLLC, P.O. BOX 52050, MINNEAPOLIS, MN, 55402, US

(21) Appl. No.: 11/528,917

(22) Filed: Sep. 28, 2006

(51) Int. Cl. H04L 12/26

(52) U.S. Cl. 370/230

(57) ABSTRACT

Embodiments of macro-spatial network multiplexing are presented herein.

### BACKGROUND

The pervasiveness of network communication is ever increasing. For example, users may utilize wired connections to obtain and transmit data, such as plain old telephone service (POTS) networks, cable, digital subscriber line (DSL), and so on. Additionally, users may have access to a wide range of wireless networks using a wide range of devices, such as desktop personal computers, laptop computers, personal digital assistants (PDAs), wireless phones, wireless routers, wireless access points (WAPs), and so on. Thus, a wide range of devices may be used to access a wide range of networks. Traditional techniques that were used to access these networks, however, typically viewed network traffic to a particular device as a single entity, which limited the device from leveraging functionality that may be available from other networks.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an exemplary implementation of an environment that is operable to employ network access techniques.

FIG. 2 is an illustration of an exemplary implementation in which the client of FIG. 1 performs macro-spatial multiplexing techniques to communicate using a plurality of network connections.

FIG. 3 is a flow diagram depicting a procedure in an exemplary implementation in which data received from a particular application is divided to be transmitted over different network connections.

FIG. 4 is a flow diagram depicting a procedure in an exemplary implementation in which data received from a plurality of applications is aggregated and divided for transmittal using a plurality of network connection devices.

FIG. 5 is a flow diagram depicting a procedure in an exemplary implementation in which a determination of which of a plurality of network connection devices to use to transmit data is made based on one or more considerations.

### DETAILED DESCRIPTION

In the following discussion, an exemplary environment and devices are described which may provide and/or utilize techniques to accomplish multiple network connections. Exemplary procedures are then described which may be employed by the exemplary environment and/or devices, as well as by other environments and/or devices without departing from the spirit and scope thereof.

Exemplary Devices

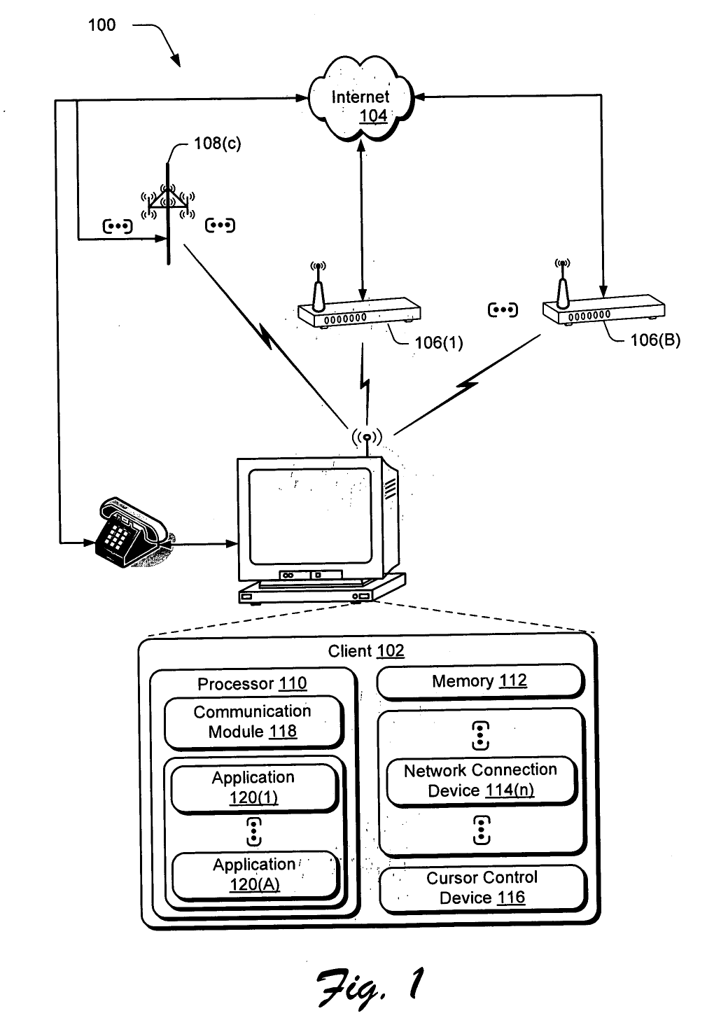

FIG. 1 illustrates an exemplary implementation of an environment 100 that is operable to employ techniques to provide a plurality of network connections. The environment 100, as illustrated, includes a client 102 communicatively coupled via a plurality of network connections to the Internet 104, although connections having a wide variety of other destinations and/or communication pathways are also contemplated without departing from the spirit and scope thereof.

The network connections are illustrated in the environment 100 of FIG. 1 as being provided using a variety of techniques. For example, the client 102 may use wired network communication techniques to form a network connection, such as through use of a plain old telephone service (POTS) as illustrated, cable, a digital subscriber line (DSL), and so on. The client 102 may also use a variety of wireless communication techniques to form a network connection, such as to communicate with base stations that may conform to a variety of standards and protocols. The client 102, for instance, may wirelessly communicate with a plurality of base stations 106(1)-106(B) that form a local area wireless network, such as a network that conforms to one or more Institute of Electrical and Electronics Engineers (IEEE) 802.11 wireless networking standards. The client 102 may also communicate over a wide area wireless network, such as through communication with one or more base stations 108(c) (where “c” can be any integer from one to “C”) that are configured to operate as a cell in a cellular network, a “WiMAX” network (i.e., a broadband wireless network based on the Institute of Electrical and Electronics Engineers (IEEE) 802.16 wireless networking standards), and so on. A variety of other instances are also contemplated.

The client 102 may be configured in a variety of different ways. For example, the client 102 is illustrated in the environment 100 of FIG. 1 as a client device, such as a traditional desktop computer (e.g., a desktop PC) as depicted, a server, a notebook computer, a personal information appliance, a network card, and so on. Further, the client 102 may be configured as a base station that receives data and forwards data, such as in a mesh network. A variety of other examples are also contemplated. In the illustrated example, the client 102 includes a processor 110, memory 112, one or more network connection device 114(n) (where “n” can be any integer from one to “N”), and a display device 116, such as a liquid crystal display (LCD).

Processors are not limited by the materials from which they are formed or the processing mechanisms employed therein. For example, processors may be comprised of semiconductor(s), transistors (e.g., electronic integrated circuits (ICs)), and/or a variety of other mechanisms. In such a context, processor-executable instructions may be electronically-executable instructions. For example, the processor 110 may execute one or more modules in response to inputs received from the cursor control device 116. Additionally, although a single memory 112 is shown, a wide variety of types and combinations of memory may be employed, such as random access memory (RAM), hard disk memory, removable medium memory, and other types of computer-readable media.

The client 102 is illustrated as executing a communication module 118 and a plurality of applications 120(1)-120(A) on the processor 110, which are also storable in memory 112. The applications 120(1)-120(A) are representative of functionality that may employ particular data for a particular purpose. For example, one or more of the applications 120(1)-12o(A) may be configured as stand-alone modules, such as a word processor, a spreadsheet application, a browser, and so on that consume and/or generate particular data, such as documents, spreadsheets and web pages, respectively. Further, the applications 120(1)-120(A) may be configured to support Voice-over-Internet Protocol (VoIP), Internet Protocol Television (IPTV), online gaming, file transfer protocol (FTP), and so on. Additionally, applications 120(1)-120(A) may be combined to incorporate different types of data, such as a media player that includes an application 120(1) for audio data and another application 120(A) for video data. Thus, applications 120(1)-120(A) are not limited to stand-alone programs but may also be representative of uses of particular data. A variety of other instances are also contemplated.

The communication module 118 is representative of functionality to manage client 102 use of network connections in the environment 100, such as use of wired connections (e.g., the POTS) and/or wireless connections (e.g., local area and/or wide area wireless networks provided by the respective base stations 106(1)-106(B), 108(c)). For example, the communication module 118 may employ Macro-Spatial-Multiplexing (MSM) to transmit data between base stations and the client 102 in overlapped coverage regions “between” the base stations (e.g., base stations 106(1)-106(B), 108(c)). The client 102, for instance, may receive different data from different base stations in order to distribute its traffic load among the base stations 106(1)-106(B), 108(c). Additionally, this data may be received from and/or transmitted using homologous sources (e.g., networks employing the same transfer protocols and/or standards) or heterogeneous sources (e.g., networks that do not employ the same transfer protocols and/or standards), such as the wide area network base stations 108(c) and the local area network base stations 106(1)-106(B).

For example, each of the base stations 106(1)-106(B), 108(c) may have a respective coverage area which overlaps with one or more other base stations. Through execution of the communication module 118, when the client 102 is within an overlapped region in a wireless network, it can transmit signals to and receive signals from a plurality of the base stations 106(1)-106(B), 108(c). Thus, rather than employ traditional techniques which view network traffic to a single client as a single entity, a plurality of network connections may be leveraged by the client 102.

For example, the data traffic from/to the client 102 may be divided into different portions, each of which travels through different base stations 106(1)-106(B), 108(c). Thus, this technique may be referred to as Macro-Spatial-Multiplexing (MSM) since different base stations 106(1)-106(B), 108(c) carry different data. MSM may be performed in a variety of ways, such as between different operators (e.g., each of the base stations 106(1)-106(B), 108(c) is associated with a different service provider), heterogeneous networks, homogeneous networks, and so on, further discussion of which may be found in relation to the following figure.

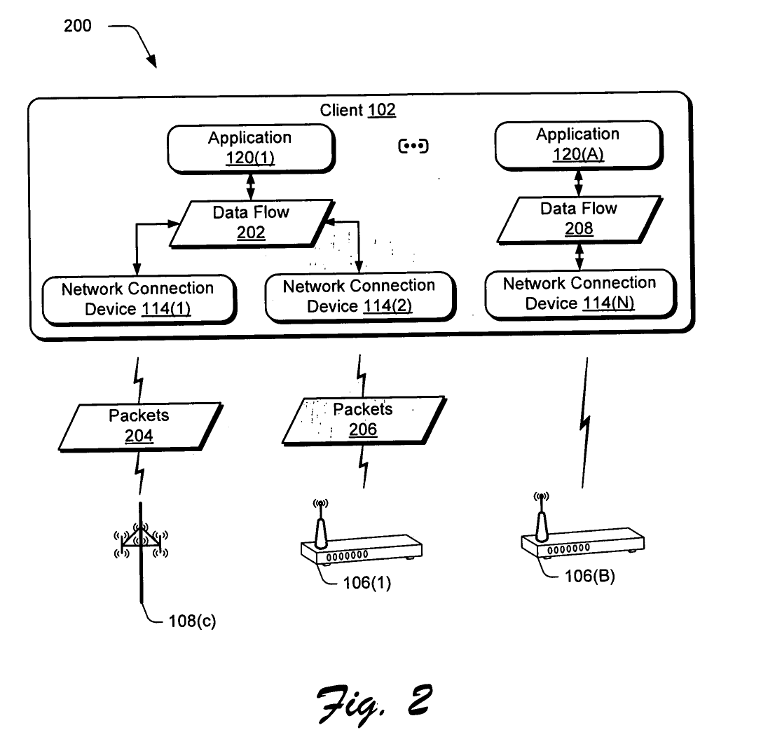

FIG. 2 depicts a system 200 in an exemplary implementation in which the client 102 of FIG. 1 performs macro-spatial multiplexing techniques to communicate using a plurality of network connections. The client 102 of FIG. 2 is illustrated as executing a plurality of applications 120(1)-120(A) that generate data to be transmitted to and/or received from a plurality of base stations 106(1)-106(B), 108(c). As previously described, MSM may be performed using a variety of techniques.

One such technique of MSM is to multiplex traffic from/to the client 102 at the packet level among different base stations. For example, the client 102 may communicate a data flow 202 from an application 120(1) over a plurality of network connection devices 114(1), 114(2) such that a first group of packets 204 are transmitted to the base station 108(c) while a second group of packets 206 are transmitted to another base station 106(1). In an implementation, the packets 204 received by base station 108(c) do not match the packets 206 received by base station 106(1). It should also be noted that in this example the packets 204, 206 are communicated over heterogeneous networks.

Another technique of MSM is to share traffic from/to the client 102 at the flow level among different base stations. For example, the data flow 208 from application 120(A) is illustrated as being communicated using network connection device 114(N) to base station 106(B) while the data flow 202 from application 120(1) is illustrated as being communicated to at least one other base station, which in this instance is base stations 108(c), 106(1) as previous described. Thus, in this example packets of data pertaining to application 120(A) are handled by base station 106(B) while packets 204, 260 from application 120(1) are handed by other base stations 108(c), 106(1). In this way, MSM at the flow level can reduce system complexity (e.g., routing packets to the right base station), simplify management (e.g., base station coordination, packet reordering, radio resource management), simplify the quantification of system performance metrics (e.g., flow block probability), and so on.

It should be readily apparent that MSM may also be implemented at a variety of other levels as well. For example, in the WiMAX context, one connection can map to multiple application flows, and the sharing may be performed at a connection level. Thus, MSM may provide flexibility to direct traffic among networks. As mentioned previously, traffic from/to a terminal is viewed as an integrated entity in traditional networks. In contrast, MSM enables load sharing at a finer level of resource granularity allowing traffic to be distributed among different base stations. This flexibility may further lead to efficient usage of network resources, reduction of flow block probability, flexibility in network load balancing, and improvement of application performance. Further, these advantages may be magnified when the client experiences relatively “heavy” traffic, the traffics are diversified, and/or the network is saturated. Further, as shown in FIG. 2 the MSM techniques are applicable to homogeneous and heterogeneous networks. Yet further, the MSM techniques may be applied in initial deployments of networks and scaled as deployments evolve.

MSM may also be utilized to leverage information from the base stations. For example, to balance network loads, the base stations could provide load information, which may then be utilized to pick particular base stations, with which, to send data. Another example is that the base stations could provide resource utilization information and participate in algorithms to efficiently utilize its resource as well as network resource, including other base stations. A third example is that, the base stations could change its admission control logic/algorithms in adapt to the partition and aggregation of client traffic so that the block probability could be reduced. A variety of other examples are also contemplated.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 112. The features of the techniques described below are platform-independent, meaning that the techniques may be implemented on a variety of commercial computing platforms having a variety of processors.

Exemplary Procedures

The following discussion describes macro-spatial network multiplexing techniques that may be implemented utilizing the previously described systems and devices. The procedures are shown as a set of blocks that specify operations performed by one or more devices and are not necessarily limited to the orders shown for performing the operations by the respective blocks.

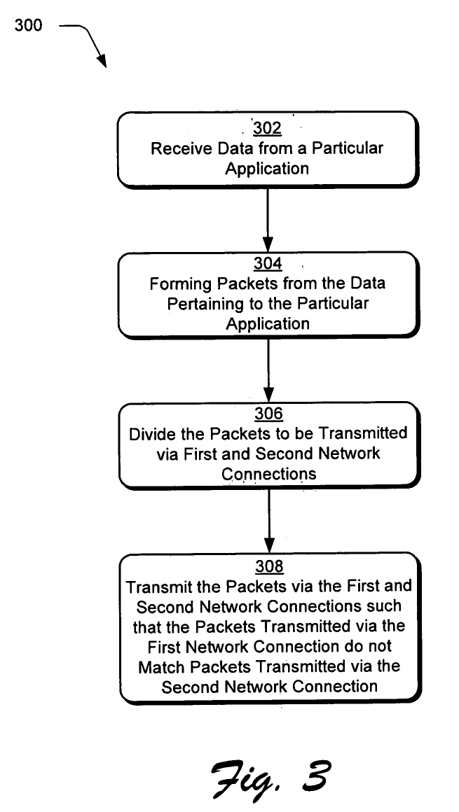

FIG. 3 depicts a procedure 300 in an exemplary implementation in which data received from a particular application is divided to be transmitted over different network connections. Data is received from a particular application (block 302). For example, the communication module 118 may receive data from application 120(1), which may be configured to address a particular type of data, configured as a stand-alone module, and so on.

Packets are formed from the data that pertains to the particular application (block 304). The packets, for instance, may be formed by the communication module 118 to include headers that identify a particular order, in which, the packets are to relate, one to another. Therefore, the headers may be used to reorder data included in the packets after transmittal.

The packets are divided to be transmitted via first and second network connections (block 306). For example, the packets may be divided for transmittal to a plurality of base stations (e.g., base stations 106(1), 106(B)) by a single network connection device, such as in a homologous network. In another example, the packets may be divided for transmittal by different respective network connection devices. In yet another example, the packets may be divided for transmittal in a heterogeneous network, such as for transmittal to base station 108(c) and base station 106(1).

The packets are transmitted via the first and second network connections such that the packets transmitted via the first network connection do not match packets transmitted via the second network connection (block 308). The data that is transmitted on the different respective network connections, for instance, may be multiplexed such that it is not substantially shared by each of the connections. Therefore, each of the network connections may be used to transmit data that is not transmitted on another one of the connections, thereby improving bandwidth available to the client 102.

Although transmission has been described, these techniques may also be applied by the client 102 when receiving data over multiple connections. In this example, the client, through execution of the communication module 118, aggregate data contained in packets received wirelessly from a plurality of base stations, in which, one or more of the packets received from a first one of the wireless connections are not received from a second one of the wireless connections. A wide variety of other examples are also contemplated.

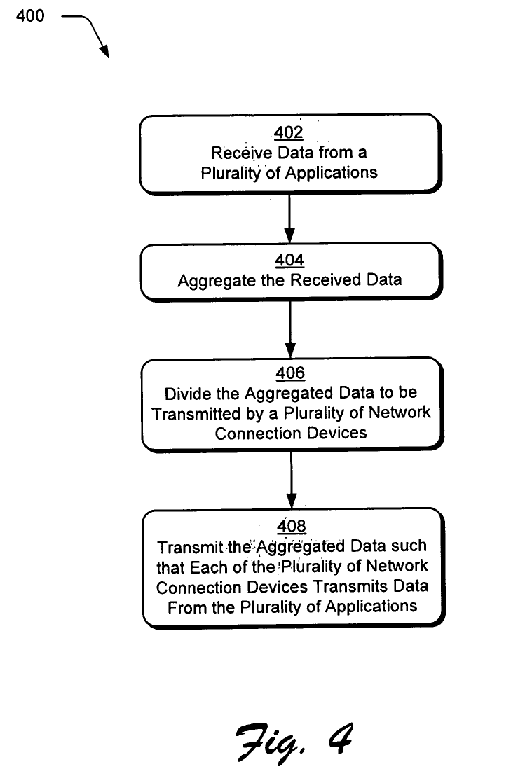

FIG. 4 depicts a procedure 400 in an exemplary implementation in which data received from a plurality of applications is aggregated and divided for transmittal using a plurality of network connection devices. Data is received from a plurality of applications (block 402), such as received by the communication module 118 from application 120(1) and application 120(A).

The received data is aggregated (block 404). For example, packets may be formed from the received data having headers that identify the respective application 120(1)-120(A) which generated the data and an order, in which, the packets are to be placed, one to another. These packets, for instance, may be combined into a single stream as received from the respective application 120(1)-120(A).

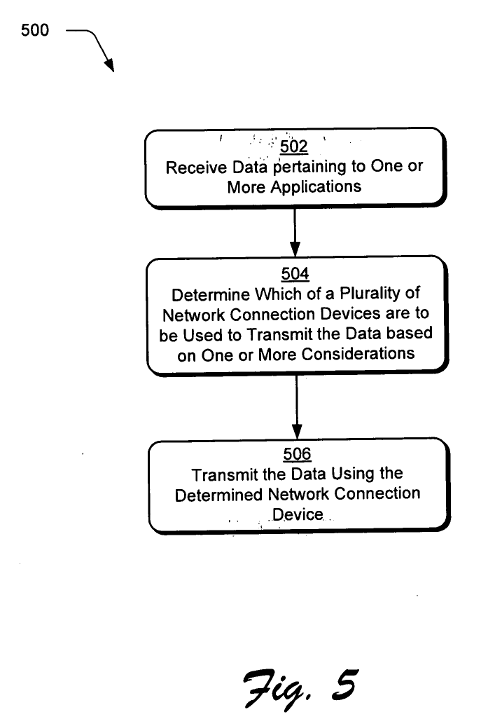

The aggregated data is divided to be transmitted by a plurality of network connection devices (block 406). The data, for instance, may be divided based on a variety of considerations, such as available bandwidth of the respective network connection devices, further discussion of which may be found in relation to FIG. 5.

The aggregated data is then transmitted such that each of the plurality of network connection devices transmits data from the plurality of applications (block 408). For instance, network connection device 114(1) and network connection device 114(2) may each transmit packets received from applications 120(1), 120(A). Therefore both applications 120(1), 120(A) may take advantage of multiple network connections. A variety of considerations may be applied to determine which network connection to use to transmit data, further discussion of which may be found in relation to the following figure.

FIG. 5 depicts a procedure 500 in an exemplary implementation in which a determination of which of a plurality of network connection devices to use to transmit data is made based on one or more considerations. Data is received that pertains to one or more applications (block 502). The data, for instance, may be received from a particular application as previously described in relation to FIG. 3 or received from a plurality of applications as previously described in relation to FIG. 4.

A determination is made as to which of a plurality of network connection devices are to be used to transmit the data based on one or more considerations (block 504). For example, the communication module 118 may make the determination automatically and without user intervention based on a quality of service (QoS) specified for particular data, available bandwidth of network connections provided by the respective network connection devices, cost in transmitting data using the network connections, and so on. Further, this determination may be based on a variety of different “levels”, such as on a “flow” level that related to data from a particular application, on a “per packet” basis, and so on. The data may then be transmitted using the determined network connection device (block 506). A variety of other examples are also contemplated.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. An apparatus comprising:
one or more network connection devices to form first and second network connections; and
a module to:
form packets from data pertaining to a particular application; and
divide the packets to be transmitted via the first and second network connections such that the packets of data to be transmitted via the first network connection do not match the packets of data to be transmitted via the second network connection.

2. An apparatus as described in claim 1, wherein the second network connection is wired.

3. An apparatus as described in claim 1, wherein the first and the second network connections are heterogeneous, one to another.

4. An apparatus as described in claim 3, wherein the first and second network connections are associated with different service providers, one to another.

5. An apparatus as described in claim 1, wherein:
the first network connection is formed via a first said network connection device; and
the second network connection is formed via a second said network connection device.

6. An apparatus as described in claim 1, wherein the first and second network connections are wireless, at least one of which conforms to one or more Institute of Electrical and Electronics Engineers (IEEE) 802.11 wireless networking standards.

7. An apparatus as described in claim 1, wherein the module is further configured to determine which of the first and second network connections are to be used to transmit particular said packets based on one or more considerations.

8. An apparatus as described in claim 7, wherein the one or more considerations are selected from a group consisting of quality of service, bandwidth and cost.

9. An apparatus as described in claim 1, wherein at least one said consideration is based, at least in part, on information received from a respective said base station.

10. An apparatus comprising:
a plurality of network connection devices;
a plurality of applications that generate data; and
a module to aggregate data from the plurality of applications and divide the aggregated data to be transmitted by the plurality of network connection devices such that each said network connection device transmits data from the plurality of applications.

11. An apparatus as described in claim 10, wherein a first said network connection device is configured to provide a network connection with a base station that is not compatible with a second said network connection device.

12. An apparatus as described in claim 10, wherein at least one of the network connection devices conforms to one or more Institute of Electrical and Electronics Engineers (IEEE) 802.11 wireless networking standards.

13. An apparatus as described in claim 10, wherein the module is further configured to determine which of the plurality of network connection devices are to be used to transmit the divided aggregated data based on one or more considerations selected from a group consisting of quality of service, available bandwidth, security and cost.

14. One or more computer-readable media comprising computer executable instructions that, when executed, direct a client to aggregate data contained in packets substantially simultaneously received wirelessly from a plurality of base stations using separate wireless connections, wherein one or more of the packets received from a first one of the wireless connections are not received from a second one of the wireless connections.

15. One or more computer-readable media as described in claim 14, wherein each of the plurality of wireless connections is associated with a different service provider, one to another.

16. One or more computer-readable media as described in claim 14, wherein:
the packets received via the first one of the wireless connections are to be associated with a first application; and
the packets received via the second one of the wireless connections are to be associated with a second application.

17. One or more computer-readable media as described in claim 14, wherein the separate wireless connections are to be provided by separate respective wireless connection devices.

18. One or more computer-readable media as described in claim 14, wherein at least one of the wireless connections conforms to one or more Institute of Electrical and Electronics Engineers (IEEE) 802.11 wireless networking standards and another one of the wireless connections does not.

19. One or more computer-readable media as described in claim 14, wherein each of the base stations is to provide Internet access.

20. One or more computer-readable media as described in claim 14, wherein at least one of the base stations is configured to support a cellular network.

21. A system comprising:
a processor to execute first and second applications;
a liquid crystal display device to provide an output relating to execution of the first and second applications;
a first network connection device to maintain a wireless wide area network connection;
a second network connection device to maintain a wireless local area network connection; and
memory to maintain the first and second applications and a module that is executable on the processor to cause data from the first application to be transmitted by the first network connection device and cause data from the second application to be transmitted by the second network connection device.

22. A system as described in claim 21, wherein:
the first network connection device is configured to communicate in compliance with one or more Institute of Electrical and Electronics Engineers (IEEE) 802.11 wireless networking standards; and
the second network connection device is configured to communicate over a wide area network.

23. A system as described in claim 22, wherein the first and second network connection devices each provide Internet access.
